(19) United States
(12) Patent Application Publication
(10) Pub. No.: US 2011/0006690 A1
(43) Pub. Date: Jan. 13, 2011

(54) APPARATUS AND METHOD FOR MANAGING THE POWER OF AN ELECTRONIC DEVICE

(75) Inventors: Brent William Hoffman, Mooresville, IN (US); Scott Charles Baxter, Carmel, IN (US)

Correspondence Address: RUBEN ARSINIEGA, 15 GLEN WILLOW CT., GREER, SC, 29650, US

(73) Assignee: SHENZHEN TCL NEW TECHNOLOGY LTD., Shekou, Shenzhen, Guangdong (CN)

(21) Appl. No.: 12/920,582

(22) PCT Filed: Jul. 16, 2008
(86) PCT No.: PCT/US08/70205

§ 371 Date: Sep. 1, 2010

(30) Foreign Application Priority Data
Mar. 18, 2008 (US) 61037632

(51) Int. Cl. H05B 37/02

(52) U.S. Cl. 315/150; 315/149

(57) ABSTRACT

An electronic device comprising a sensor adapted to sense ambient light and an indicator adapted to display a power consumption status. The electronic device may additionally comprise a processor adapted to vary the luminosity of the device based on the ambient light sensed. A method may comprise sensing ambient light, illuminating a display at a luminosity based on the ambient light, and displaying a power consumption status on the device.

### FIELD OF THE INVENTION

The present invention relates generally to electronic devices. More particularly, the present invention relates to a method and device relating to varying luminosity of a display on an electronic device.

### BACKGROUND OF THE INVENTION

This section is intended to introduce the reader to various aspects of art which may be related to various aspects of embodiments of the present invention which are described and/or claimed below. This discussion is believed to be helpful in providing the reader with background information to facilitate a better understanding of the various aspects of embodiments of the present invention. Accordingly, it should be understood that these statements are to be read in this light, and not as admissions of prior art.

Electronic devices, such as televisions, often include a light source that is used to illuminate the display of the device. For example, a television set may include a cathode ray tube or cold cathode fluorescent lamps (CCFL) located behind the display. Typically, the light source is the largest contributor to power consumption of the device. For example, the light source in a large screen liquid crystal display (LCD) panel may account for as much as 80% of the total power consumption. For both environmental and economic reasons, consumers are concerned about reducing power consumption. It is now recognized that there is a need for an improved design which facilitates reduced power consumption and monitoring for electronic devices.

### BRIEF DESCRIPTION OF THE DRAWINGS

Advantages of embodiments of the present invention may become apparent upon reading the following detailed description and upon reference to the drawings in which:

FIG. 1 is a block diagram of an electronic device in accordance with an embodiment of the present invention;

FIG. 2 is a graphical representation of a relationship between ambient light and luminosity of a light source in accordance with an embodiment of the present invention;

FIG. 3 is front elevational view of an electronic device in accordance with an embodiment of the present invention; and

FIG. 4 is a process flow diagram of a method in accordance with an embodiment of the present invention.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

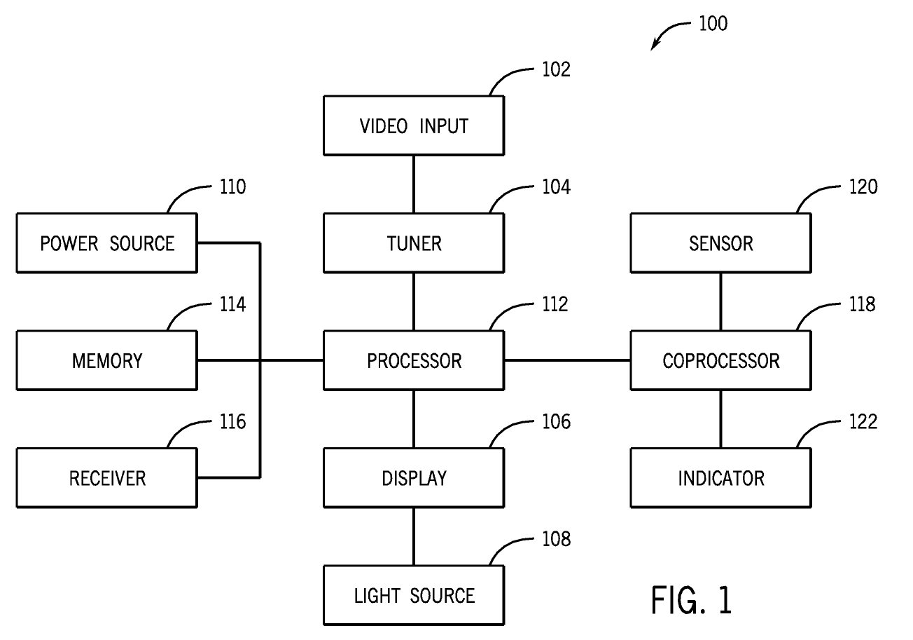

FIG. 1 is a block diagram of an electronic device in accordance with an exemplary embodiment of the present invention. The electronic device is generally indicated by reference number 100. The electronic device 100 (a television, for example) comprises various subsystems represented as functional blocks in FIG. 1. Those of ordinary skill in the art will appreciate that the some of the functional blocks shown in FIG. 1 may comprise hardware elements (including circuitry), software elements (including computer codes stored on a machine-readable medium), or a combination of both hardware and software elements.

The electronic device 100 includes a media input, such as video input 102, for receiving media to present via the electronic device 100. The video input 102 may be adapted to receive video from a variety of sources. For example, the video input 102 may be an antenna or satellite for receiving broadcasts transmitted over the airwaves. In another embodiment, the video input 102 may be a cable input for receiving cable television channels. In yet other embodiments, the video input 102 may be a computer interface, a memory card reader, or an input for receiving information from an optical disc or the like. In some embodiments, the video input 102 may contain an audio input for receiving sound which may, or may not, correspond to the video received.

In the illustrated embodiment, a tuner 104 receives a signal from the video input 102 and uses the signal to select a media program for presentation. For example, the tuner 104 may be used to select and tune a channel from a variety of channels provided through cable television to display a program being broadcast on the tuned channel. As those of ordinary skill in the art will appreciate, certain video inputs such as those from a DVD player or memory card may bypass the tuner 104 because tuning is not required to isolate a video program associated with such signals.

Information received from the video input 102 may be displayed on a display 106 of the electronic device 100. The display 106 may be a liquid crystal display (LCD), a light emitting diode (LED) display, a plasma display panel (PDP), a digital light projection (DLP), or other suitable display. A light source 108, typically located behind the display 106, may be used to generate a visible image on the display 106. The light source 108 may be a back-light-unit (BLU) containing florescent bulbs. In an embodiment employing an LCD panel as the display 106, the back-light-unit may utilize cold cathode florescent lamps (CCFL). In other embodiments, the light source 108 may include other light producing devices such as a cathode ray tube (CRT). As those of ordinary skill in the art will appreciate, the light source 108 also may include additional devices for directing light towards the display 106. For example, the light source 108 may include a mirror for reflecting light towards a display panel and may include defusing and polarizing elements for creating a uniform back-light distribution.

The electronic device 100, including the light source 108, may be powered by a power source 110. The power source 110 may include one or more batteries and/or an AC power source, such as provided by an electrical outlet. In other embodiments, an AC or DC power source may be directly wired to the electronic device 100 through a terminal block or other power supply configuration.

A processor 112 is included as a component of the electronic device 100 to control operation of the device 100 and may be adapted to execute instructions received from the video input 102. In operation, the processor 112 may interact with a memory 114 that stores executable code and instructions for the processor 112. For example, the memory 114 may be a computer-readable medium or machine-readable medium adapted to hold instructions or code used by the processor 112 to control the operation of the electronic device 100. Among other things, the memory 114 may store data, code, or instructions relating to a relationship for adjusting luminosity of the light source 108 in response to a level of ambient light present near the electronic device 100. Further, the memory 114 may store data, code, or instructions relating to an on-screen or external display feature configured to indicate power savings in accordance with present embodiments.

The processor 112 also may be adapted to execute instructions received through a receiver 116. The receiver 116 may be any suitable receiver adapted to receive commands from another device. For example, the receiver 116 may be an infrared receiver that receives infrared signals generated by a remote control. In other embodiments, the receiver 116 may be adapted to receive radio frequency signals such as those employing the Bluetooth standard.

In some embodiments, the processor 112 may contain components such as integrated circuits allowing additional functionality of the electronic device 100. For example, the processor 112 may contain an analog-to-digital (A/D) converter for converting incoming signals. The analog-to-digital converter may interact with other components contained within the processor 112, such as gain circuits and filters, to perform signal processing functions. Additionally, the processor 112 may include a pulse-width modulator (PWM) for controlling circuitry and power consumption of subsystems such as the light source 108.

The illustrated embodiment includes a coprocessor 118. Various processing functions within the electronic device 100 may be performed by the coprocessor 118. The coprocessor 118 may be integrated within the processor 112, or it may exist as a separate component. In some embodiments, the coprocessor 118 may be a floating point unit (FPU) that is specially designed to perform floating point arithmetic. For example, in an embodiment where the electronic device 100 employs ARM (Advanced RISC Machine) architecture, the processor 112 may be an ARM core processor and the coprocessor 118 may be a floating point accelerator (FPA). In other embodiments employing ARM architecture, the coprocessor 118 may be another type of floating point coprocessor such as a vector floating point (VFP) processor, a floating point emulator (FPE) or an Intel® wireless MMX™ technology processor (IWMMXt). In addition to floating point arithmetic, the coprocessor 118 may be adapted to perform a wide variety of functions, including, but not limited to, signal processing, graphics, and string processing.

In one embodiment, the coprocessor 118 may be adapted to facilitate operation of a sensor 120 and an indicator 122. However, in other embodiments, the coprocessor 118 may not be present in the device, and the processor 112 may facilitate operation of the sensor 120 and indicator 122. One embodiment may operate such that the sensor 120 senses the level of ambient light present near the electronic device 100 and transmits corresponding signals to the processor 112. Using these signals, the device 100 may adjust the luminosity, or brightness, of the light source 108 and determine a power consumption status. For example, if the ambient light is low, the brightness of the light source 108 may be adjusted down and the power consumption may subsequently be measured to identify a power consumption status (for example, a level of power consumption or a difference between current and previous power consumption levels). This power consumption status may be displayed on the indicator 122. The sensor 120 may be any type of sensor capable of sensing ambient light, such as a photo resistor, a light-dependent resistor (LDR), a photo diode, or the like. The indicator 122 may be any type of indicator capable of displaying a status, such as one or more light emitting diodes (LEDs) or a graphical display. In some embodiments, the display 106 may be utilized to provide an on-screen indication of the power consumption status.

As noted above, the light source 108 may account for a large amount of the power consumption of the electronic device 100. Therefore, in some embodiments, the power consumption status may represent the power use of the light source 108. In other embodiments, the power consumption may represent the overall power use of the device 100, including power consumed by other components in addition to the light source 108, such as the tuner, audio controller, and standby mode mechanism.

The processor 112 and/or the coprocessor 118 may be adapted to use ambient light signals from the sensor 120 to control operation of the light source 108. Specifically, the ambient light level detected by the sensor 120 may be employed by the processor 112 and/or the coprocessor 118 to determine the luminosity level to be supplied by the light source 108. For example, when the sensor 120 detects low ambient light, the processor 112 may decrease the luminosity of the light source 108 to a correspondingly low level or to a minimum level to facilitate viewing of the display 106 in a darkened room. In some embodiments, low ambient light may occur when the level of ambient light represents less than 25% of the amount of ambient light detectable by the sensor 120. When low ambient light levels are detected, the processor 112 may operate the light source 108 at approximately 50% of its luminosity capacity. Similarly, when the sensor 120 detects high ambient light, the processor 112 may increase the luminosity to a correspondingly high level or to a maximum level to facilitate viewing of the display 106 in a bright environment. In some embodiments, high ambient light may occur when the level of ambient light represents more that 75% of the amount of ambient light detectable by the sensor 120. When high ambient light levels are detected, the processor 112 may operate the light source 108 at approximately 100% of the luminosity capacity. In another example, when the sensor 120 detects a change in the ambient light level, the processor 112 may increase or decrease the luminosity in response to the increase or decrease in ambient light.

In some embodiments, the luminosity of the light source 108 may be bounded by maximum and minimum luminosity levels stored within the electronic device 100. The processor 112 may use the minimum luminosity level to determine a minimum amount of luminosity for the light source. For example, if the light source 108 is already emitting luminosity at the minimum level and the sensor 120 detects a decrease in ambient light, the processor 112 may maintain the luminosity at the minimum level. Similarly, the processor 112 may use the maximum luminosity level to determine a maximum amount of luminosity for the light source. For example, if the light source 108 is already emitting luminosity at the maximum level and the sensor 120 detects an increase in ambient light, the processor 112 may maintain the luminosity at the maximum level.

These minimum and maximum levels may be set by the device manufacturer or adjusted by a user and may be used to control power consumption of the electronic device 100. As previously noted, the light source 108 may account for a large portion of the power consumption of the electronic device 100. As the luminosity of the light source 108 increases, the light source 108, and consequently the electronic device 100, consumes more power. In order to conserve additional power, a user or manufacturer may decrease the minimum and maximum luminosity levels so the light source 108 is operating within a lower range of luminosity levels.

In accordance with present embodiments, the indicator 122 or the display 106 presents a status corresponding to the power consumption status of the electronic device 100, thereby allowing a user to monitor the power consumption of the device 100. For example, when the light source 108 is illuminating the display 106 at the minimum luminosity level, the device 100 may display a minimum power status on the indicator 122. Similarly, when the light source 108 is illuminating the display 106 at the maximum luminosity level, the device 100 may display a maximum power status on the indicator 122. When the light source 108 is illuminating the display 106 in between the maximum and minimum luminosity level, the device 100 may display a power savings status on the indicator. The power savings status may indicate that the device 100 is not operating at full power consumption, and is thus conserving power. In summary, the indicator 122 displays a status that informs the user if the device 100 is consuming the maximum amount of power, the minimum amount of power, or an intermediate amount of power somewhere within the maximum and minimum power consumption range.

In some embodiments, the indicator 122 may be a light emitting diode (LED). The LED may be a bi-colored LED capable of emitting light at two different colors corresponding to the power status of the device 100. For example, the LED may emit a green light to indicate minimum power status when the light source 108 is emitting the minimum luminosity. The LED may emit a red light to indicate maximum power status when the light source 108 is emitting the maximum luminosity. Further, when the light source 108 is emitting an intermediate luminosity, the LED may emit both the red and green lights, resulting in a yellow light indicating the power savings status. Consequently, the color of the indicator 122 may provide a visible indication of the power consumption status of the device 100. In some embodiments, the indicator 122 may be configured to transition a color of light emission from red to yellow and then to green as power consumption goes from a maximum level to a minimum level. For example, if a power consumption status is high but not a maximum, the light emission may have an orange color. In other embodiments, other colors may be utilized. For example, blue may be utilized instead of green.

In other embodiments a single color LED may be used to indicate the power consumption of the device. The light may be activated to indicate one status and deactivated to indicate another status. For example, a red LED may be activated to emit a red light when the light source 108 is emitting the maximum luminosity or operating within a maximum luminosity range, thereby indicating maximum power status. The red LED may be deactivated when the light source 108 is emitting less than the maximum luminosity, thereby indicating a power savings status or a minimum power status. As those skilled in the art will appreciate, an LED containing any number of colors may be used to indicate the power consumption of the device. For example, an LED capable of emitting four colors of light may be used to indicate four different statuses, such as minimum power status, moderate power status, high power status, and maximum power status.

The indicator 122 also may be a graphical or textual display viewable on the display 106. For example, a graphical display indicator may include a pictorial representation, such as status bars, that represents the power consumption of the device at any range between the maximum and minimum power levels. In some embodiments, the device may vary the number of status bars displayed in response to changes in the luminosity of the light source. For example, when the light source is operating at 50% of its luminosity, two status bars may be displayed. However, when the light source is operating at 100% of its luminosity, ten status bars may be displayed. In another embodiment, a textual display indicator may display words, such as “minimum power status” or “power savings status,” corresponding to the power status of the device 100. In yet other embodiments, the indicator 122 may be a combination of lights which vary in color or intensity in response to power consumption of the device.

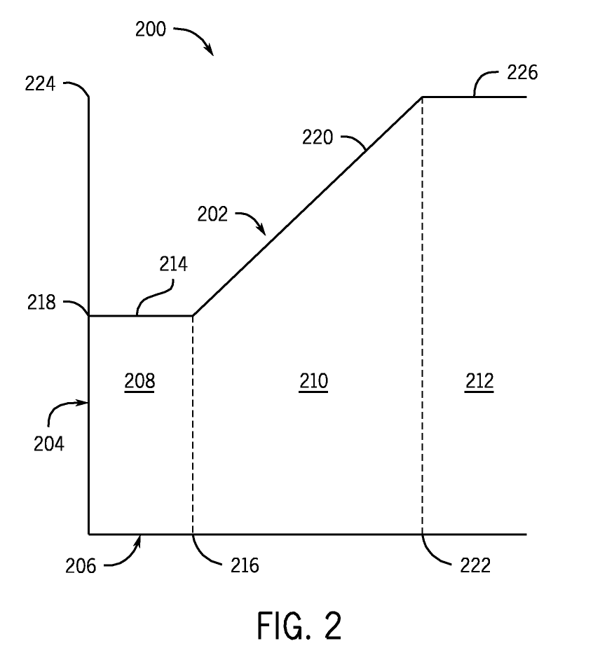

FIG. 2 includes a graph 200 representing a relationship 202 that the processor 112 may use to vary light source luminosity 204, as represented by the y-axis, in response to an ambient light level 206, as represented by the x-axis. For example, the relationship 202 could be an equation, algorithm, or series thereof that correlates the ambient light level 206 to the light source luminosity 204. As discussed regarding FIG. 1, the ambient light level 206 may be measured by the sensor 120 (FIG. 1), while the light source luminosity 204 represents the level of luminosity generated by the light source 108 (FIG. 1). As the ambient light level 206 changes, the electronic device 100 may adjust the light source luminosity 204 using the relationship 202. The relationship 202 may be stored within a device subsystem, such as the memory 114 (FIG. 1).

In the depicted embodiment, the relationship 202 defines three levels, or modes, of power consumption: a minimum power status mode 208, a power savings status mode 210, and a maximum power status mode 212. Each of the three levels occurs for a different range of ambient light. For example, when the ambient light level 206 is low, which in some embodiments may occur when the ambient light represents less than 25% of the detectable ambient light range, the electronic device 100 operates in the minimum power status mode 208. When the ambient light level 206 is high, which in some embodiments may occur when the ambient light represents greater than 75% of the detectable ambient light range, the device 100 operates in the maximum power status mode 212. The area in between the minimum status power mode 208 and the maximum status power mode 212 is the power saving status mode 210, which occurs when the ambient light level 206 is at an intermediate level.

The device 100 is adapted to determine the light source luminosity 204 for each of these respective power status modes using the relationship 202. When the device 100 is in the minimum power status mode 208, a minimum power portion 214 of the relationship 202 determines the light source luminosity 204. As shown, the minimum power portion 214 may be expressed in the linear form y=b, where the luminosity of the light source (y) is defined as a constant value (b). The device may use the minimum power portion 214 to determine the luminosity 204 whenever the ambient light level 206 falls below a lower threshold 216. Specifically, when the ambient light level 206 falls below the lower threshold 216, the device 100 may set the light source luminosity 204 at a minimum level 218. This minimum level 218 may correspond to a minimum luminosity level stored within the device 100 that may be set by a user or device manufacturer. Although the minimum power relationship 214 is shown in the linear form y=b, those skilled in the art will appreciate that the minimum power portion 214 may be defined as any other type of relationship, such as a polynomial or exponential relationship.

The power savings status mode 210 is defined by a power savings portion 220 of the relationship 202. Therefore, when the device 100 is in power savings status mode 210, the power savings portion 220 determines the light source luminosity 204. As shown, the power savings portion 220 may be expressed in the linear form y=mx+b where the light source luminosity (y) is determined by the equation mx+b. The terms “m” and “b” represent constant values which may be stored in the memory 114 (FIG. 1), and the term “x” represents the ambient light level 206. Therefore, the light source luminosity 204 can be determined when the device is in the power savings status mode 210 by substituting the ambient light level 206 into the equation for the term “x.”

The power savings portion 220 may be used to determine the luminosity 204 whenever the ambient light level is greater than or equal to the lower threshold 216 and less than or equal to an upper threshold 222. Although the power savings portion 220 is illustrated as a linear relationship, as those skilled in the art will appreciate, the power savings relationship may be defined as any other type of relationship, such as a polynomial or exponential relationship. Additionally, the power savings status mode 210 may be divided into sub-modes each represented by a different type of relationship.

The maximum power status mode 212 is defined by a maximum power portion 226 of the relationship 202. Therefore, when the device 100 is in the maximum power status mode 212, the device 100 may use the maximum power portion 220 to determine the light source luminosity 204. Similar to the minimum power portion 214, the maximum power portion 226 is expressed as a constant equation. Again, this may be in the form of y=b where the light source luminosity (y) is a constant value (b). The device may use maximum power portion 226 to determine the luminosity 204 whenever the ambient light level 206 is greater than an upper threshold 222. When the ambient light level 206 is greater than the upper threshold 222, the light source luminosity 204 is set at a maximum level 224. This maximum level 224 may correspond to a maximum luminosity level stored within the device 100 that may be set by a user or device manufacturer. Although the maximum power relationship 226 is shown in the linear form y=b, those skilled in the art will appreciate that the maximum power portion 226 may be defined as any other type of relationship, such as a polynomial or exponential relationship.

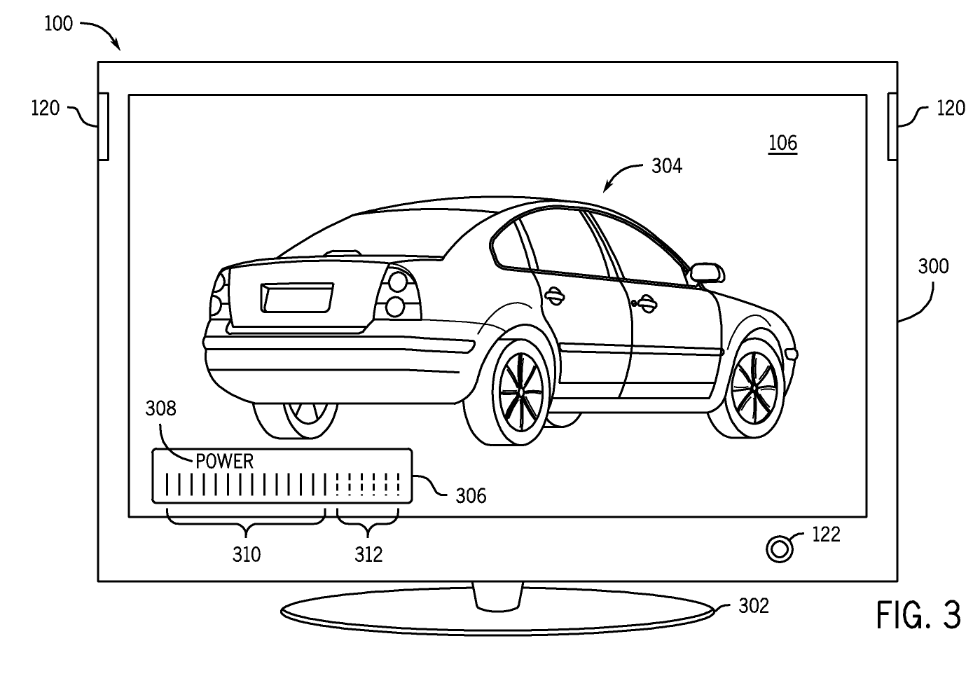

FIG. 3 is an elevational view of one embodiment of the electronic device 100 in accordance with an embodiment of the present invention. The electronic device 100 includes a frame 300 that encloses the display 106 of the electronic device 100. The display 106 and frame 300 are supported by a base 302. The frame 300 and base 302 may be any material capable of supporting the display 106, such as a plastic or metal composite material. An image 304, depicted as a vehicle in FIG. 3, may be shown on the display 106, and may be based on information received from the video input 102 (FIG. 1). The light source 108 (FIG. 1) may be located behind the display 106, and the light source luminosity 204 (FIG. 2) may be adjusted to facilitate viewing of the image 304. The sensors 120, which are shown on each side of the frame 300, are adapted to sense ambient light levels 206 (FIG. 2) used by the device to adjust the light source luminosity 204 (FIG. 2). In other embodiments, a single sensor 120 may be utilized and the location of the sensor(s) 120 may vary. The indicator 122, which is shown at the bottom of the frame 300, is adapted to provide an indication of a current power status mode, such as one of the modes described with respect to FIG. 2. Although the indicator 122 is depicted as an LED, other types of light sources may be employed in other embodiments.

In addition to the indicator 122, FIG. 3 illustrates a graphical display 306 which may be used to indicate the power status. The graphical display 306 may be used instead of, or in addition to, the indicator 122. Including the indicator 122 separate from the display 106 (such as on the frame 300) may facilitate providing a user with a power consumption status without accessing an on-screen display. A user may access the graphical display 306 using a remote device such as a remote control in communication with the receiver 114. The graphical display 306 may include text 308 that displays information about the graphical display. For example, in this embodiment, the text 308 displays the word “power” to indicate that the graphical display 306 relates to the power consumption of the device 100. The graphical display 306 also may include status bars 310 and 312 that may be used to indicate the power consumption level of the device 100. As power consumption increases, the device 100 may cause status bars to light up consecutively, producing lit status bars 310. Other status bars 312 may remain unlit until the power consumption reaches a corresponding level. The unlit status bars 312 may indicate the amount of power consumption not being utilized. As those skilled in the art will appreciate, although the graphical display 306 here incorporates status bars 310 and 312, other suitable features may be used to indicate power consumption of the device 100. For example, the graphical display 306 may include graphical icons or colored lights similar to those used in the LED indicator 122. In some embodiments, the graphical display 306 may be incorporated into the frame 300 of the device 100. In yet other embodiments, the graphical display 306 may be replaced by a textual display.

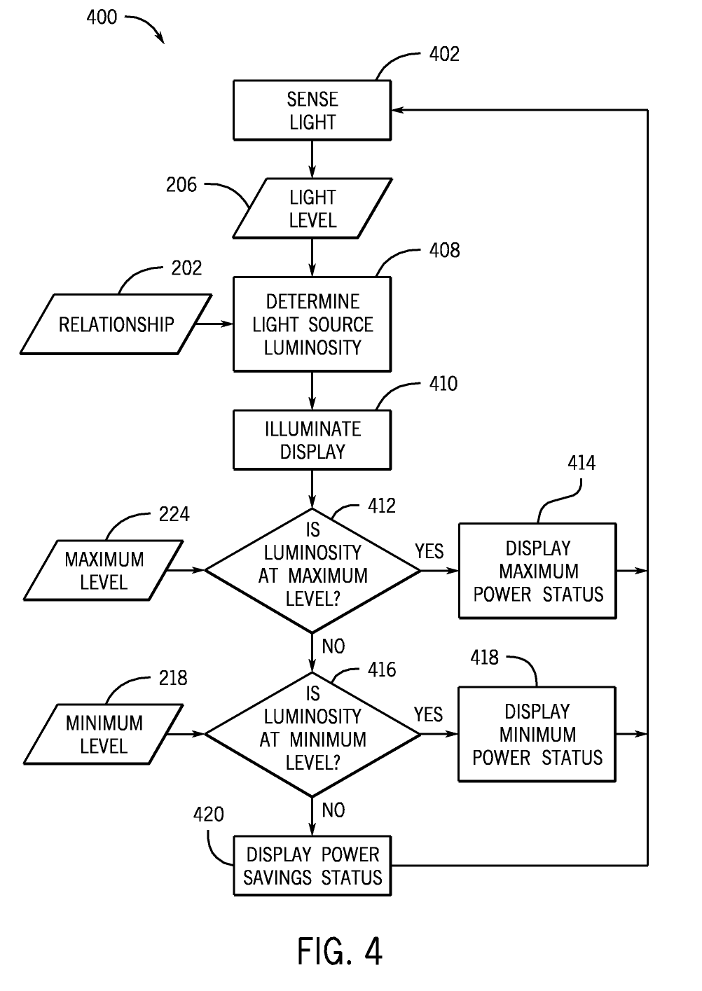

FIG. 4 is a process flow diagram of a method 400 in accordance with an embodiment of the present invention. In some embodiments, as would be appreciate by one of ordinary skill in the art, some steps may be modified, excluded, or additional steps may be included. The method 400 begins with step 402, sensing light. The sensor 120 (FIG. 1) is used to sense ambient light and send signals to the processor 112 (FIG. 1) for determination of the ambient light level 206. The light level 206 is then used in conjunction with the relationship 202 to determine light source luminosity (step 408). As discussed above in regard to FIG. 2, the relationship 202 may be stored in the electronic device 100 and may consist of several portions including the minimum power portion 214 (FIG. 2), the maximum power portion 226 (FIG. 2), and the power savings portion 220 (FIG. 2). The portions 214, 226, and 220 of the relationship 202 that are used may vary depending on the ambient light level 206.

After the relationship 202 is used to determine the light source luminosity (step 408), the electronic device 100 illuminates the display 106 (step 410) at the determined luminosity. In some embodiments, the processor 112 (FIG. 1) may send a pulse-width modulation signal to the light source 108 (FIG. 1) to illuminate the display 106 (FIG. 1). After illuminating the display 106, the electronic device 100 then determines if the luminosity is at the maximum level (step 412). As noted above, the maximum level 224 (FIG. 2) may be stored within the memory 114 (FIG. 1). If the luminosity corresponds to a maximum level, the electronic device 100 displays the maximum power status (step 414). The maximum power status 212 (FIG. 2) may be displayed on the indicator 122 (FIG. 1). If the luminosity does not correspond to a maximum level, the device 100 determines if the luminosity is at a minimum level (step 416). As noted above, the minimum level 218 (FIG. 2) may be stored within the memory 114 (FIG. 1). If the luminosity corresponds to the minimum level, the electronic device 100 displays a minimum power status on the indicator (step 418). The minimum power status 208 (FIG. 2) may be displayed on the indicator 122 (FIG. 1). If the luminosity is not at the minimum level, the device 100 displays the power saving status (step 420). Again, the power savings status 210 (FIG. 2) may be displayed on the indicator 122 (FIG. 1).

Each of the statuses 208, 210, and 212 (FIG. 2) may be displayed on the indicator 122 or 306 of the device 100. In some embodiments employing an LED indicator, the processor 112 (FIG. 1) may control display of the power status by sending a pulse-width modulation signal to the LED. The pulse-width modulation signal may vary to enable different colored lights included within the LED. For example, the processor 112 (FIG. 1) may vary the pulse-width modulation signal to enable a first color of the LED when the luminosity is at the minimum level. When the luminosity is at a maximum level, the processor 112 (FIG. 1) may vary the pulse-width modulation signal to enable a second color of the LED. Finally, when the luminosity is a value in between the minimum and maximum level, the processor 112 (FIG. 1) may vary the pulse-width modulation signal to enable both LED colors. In some embodiments, multiple level measures and corresponding colors may be utilized to indicate various levels of power conservation.

Returning to FIG. 4, after displaying the power status (steps 414, 418 and 420), the method 400 begins again with sensing light (step 402). By repeating the process of sensing light (step 402), illuminating a display (step 410) and displaying a power status (steps 414, 418, and 420), the device 100 is able to adjust light source luminosity as the ambient light level changes.

While embodiments of the present invention may be susceptible to various modifications and alternative forms, specific embodiments have been shown by way of example in the drawings and are described in detail herein. However, it should be understood that the invention is not intended to be limited to the particular forms disclosed. Rather, the invention is to cover all modifications, equivalents and alternatives falling within the spirit and scope of embodiments the present invention as defined by the following appended claims.

What is claimed is:

1. A method of operation of an electronic device, the method comprising:
sensing an ambient light level;
illuminating a display of the electronic device at a luminosity level corresponding to the ambient light level; and
displaying a status on the electronic device, the status relating to a level of power consumption of the electronic device.

2. The method of claim 1, comprising determining the status by comparing the luminosity level to a maximum level stored within the device and a minimum level stored within the device.

3. The method of claim 1, comprising adjusting the luminosity level in response to changes sensed in the ambient light level.

4. The method of claim 1, comprising determining the luminosity level using a relationship stored in the device.

5. The method of claim 1, wherein the status corresponds to a maximum power status, a minimum power status, or a power savings status.

6. The method of claim 1, wherein illuminating the display comprises sending a pulse-width modulation signal to a light source.

7. The method of claim 1, wherein displaying the status comprises sending a pulse-width modulation signal to an indicator located within the electronic device.

8. The method of claim 1, comprising displaying the status via an indicator separate from the display, wherein the indicator comprises an LED.

9. The method of claim 8, comprising displaying the status via a bi-color light emitting diode (LED).

10. The method of claim 9, comprising:
varying the pulse-width modulation signal to enable the LED to emit light of a first color when the luminosity level (corresponds to a minimum level stored within the device;
varying the pulse-width modulation signal to enable the LED to emit light of a second color when the luminosity level corresponds to a maximum level stored within the device; and
varying the pulse-width modulation signal to enable the LED to emit light of the first color and light of the second color when the luminosity level is a value between the minimum level and the maximum level.

11. An electronic device, comprising:
a sensor that is adapted to sense ambient light;
a light source that is adapted to illuminate a display of the electronic device;
an indicator that is adapted to display a status relating to power consumption of the electronic device; and
a processor that is adapted to vary a luminosity of the light source based on the ambient light and determine the status using the luminosity.

12. The device of claim 11, wherein the processor is adapted to vary the luminosity using a relationship stored within a memory of the electronic device, the relationship providing levels of the luminosity of the light source corresponding to levels of the ambient light.

13. The device of claim 11, wherein the electronic device comprises a television.

14. The device of claim 11, wherein the sensor comprises a light dependent resistor (LDR).

15. The device of claim 11, wherein the light source comprises a backlight illumination system including at least one fluorescent tube.

16. The device of claim 11, wherein the indicator is separate from the display.

17. The device of claim 11, wherein the indicator comprises a graphical display accessible through a menu of the electronic device.

18. The device of claim 11, wherein the sensor and the indicator are controlled by a floating point coprocessor located within the device.

19. A tangible machine-readable medium, comprising:
first instructions stored on the tangible machine-readable medium, the first instructions adapted to receive data corresponding to an ambient light level;
second instructions stored on the tangible machine-readable medium, the second instructions adapted to determine luminosity for a light source using a relationship relating the ambient light level to the luminosity;
third instructions stored on the tangible machine-readable medium, the third instructions adapted to display a maximum power status if the luminosity corresponds to a maximum level;
fourth instructions stored on the tangible machine-readable medium, the fourth instructions adapted to display a minimum power status if the luminosity corresponds to a minimum level; and
fifth instructions stored on the tangible machine-readable medium, the fourth instructions adapted to display a power savings status if the luminosity corresponds to a value between the minimum level and the maximum level.

20. The tangible machine-readable medium of claim 17, wherein the maximum level and the minimum level are user input values.
